(19) United States
(12) Patent Application Publication
(10) Pub. No.: US 2008/0078782 A1
(43) Pub. Date: Apr. 3, 2008

(54) Rotary pump plural component applicator

(76) Inventor: Frank C. Bien, Apopka, FL (US)

Correspondence Address: William M. Hobby, III, Suite 375, 157 E. New England Avenue, Winter Park, FL, 32879, US

(21) Appl. No.: 11/905,428

(22) Filed: Oct. 1, 2007

Related U.S. Application Data
(60) Provisional application No. 60/848,851, filed on Oct. 3, 2006.

(51) Int. Cl. B67D 5/52; B67D 5/62; B65D 88/54; B60P 3/22

(52) U.S. Cl. 222/139; 222/318; 222/608; 222/146.5

(57) ABSTRACT

A rotary pump plural component applicator apparatus is provided for dispensing plural components, such as resins and adhesives or the like, with an activator for the resins or adhesives. A plural component applicator uses an electric motor gear box driving first and second rotary pumps. The use of an electric motor driving plural rotary pumps improves the plural component applicator performance in the application of the plural components.

### BACKGROUND OF THE INVENTION

This application claims the benefit of U.S. Provisional Application No. 60/848,851, filed Oct. 3, 2006.

The present invention relates to a plural component applicator in which multiple chemicals are metered prior to dispensing of the mixture and to an electrically operated rotary pump proportioning and dispensing system which may be operated in the field while maintaining precision ratios of liquid components under different physical conditions.

Multiple component delivery pumps are used when two or more materials have to be combined to obtain a desired product prior to dispensing the mixture. The process generally has to ensure that the ratio between the components is maintained accurately and continuously. This is true, for example, when components of plastic materials are delivered which cure by chemical reaction. Multiple component dispensing systems for dispensing resins, adhesives, acrylic materials, urethanes and the like are well known and currently marketed by various manufacturers.

These prior systems operate satisfactory but have several operational disadvantages as a result of being operated pneumatically through plural piston-type pumps. Typically, a multi-component dispensing system has an air operated drive motor operatively connected to a pair of metering piston pumps which serves to dispense materials, such as adhesive materials, or resins and an associated activator. These prior metering pumps typically are air driven or gear driven by means of a drive gear mounted to a drive motor. The drive motor in turn drives a pair of piston pumps which pump the liquid materials from mixing prior to dispensing.

The concept of using a pair of piston pumps which are mechanically connected and operated by one power source for delivery of multi-components from separate tanks is well known. The operation of a piston pump produces slight variations in the mixture due to the cycling of the piston in the pumps. A reciprocating pump must change direction at the end of every stroke, similar to an engine; the piston reaches top dead center and is reversed. Each time a piston pump changes direction, the balls must re-set and send fluid in the opposite direction, showing gauge bounce or dip. If gauges could read fast enough, you would see pressure go to zero at top and bottom of each stroke if not for hose expansion, check valve and fluid reservoirs. Various techniques have been used to minimize this effect including using larger hoses, pumps and the like.

The present invention advantageously utilizes plural rotary pumps driven by a single power source for simultaneously applying metered amounts of liquids from separate tanks into a mixing nozzle where they are mixed and dispensed. Rotary pumps which are electrically driven are used in dispensing of the liquids.

Prior plural component application machines have generally been unable to maintain an exact ratio of two materials desired at a controlled temperature to achieve a uniform mix of materials at the spray nozzle. Most prior plural applicator machines use compressed air motors to drive a pair of piston pumps, one for each material. This results in a lead-lag in the material flow when the pistons pump stop and change direction since the pumps do not lead-lag at the same time thereby varying the ratio of material during a cross-over of the pistons sometimes causing clogging or stoppage of flow to materials. The materials are reactive when mixed together even for an instant which can cause a reaction, clogging or stopping the machine.

### SUMMARY OF THE INVENTION

A rotary pump plural component applicator is provided for dispensing plural components, such as resins and adhesives or the like, along with an activator for the resins and adhesives. The plural component applicator has an electric motor having a drive shaft connected to a gear box to drive first and second rotary pumps, each pump having an input and an output. A first storage tank is connected to the first rotary pump input while a second storage tank connects to a second rotary pump input. A first heater is coupled to the first rotary pump output for heating a liquid from the pump output while the second heater is coupled to the second rotary pump output for heating a liquid from the second rotary pump output. The first dispensing valve is connected to the first heater and to an applicator nozzle while a second dispensing valve is connected to the second heater for dispensing the heated liquid to the applicator nozzle. Thus, an electric motor driven rotary pump plural component applicator improves the ratio of the mixed components and of the application of the components. A first three-way valve is connected between the storage tank in the first rotary pump for directing a liquid from the first storage tank or from an auxiliary storage tank to the first rotary pump input. A second three-way valve is connected between the second storage tank and the second rotary pump for directing liquid from the second storage tank or from an auxiliary storage tank to the second rotary pump input. The rotary pump plural component applicator is mounted on a wheeled cart having an electric motor and gear box mounted generally vertical on the cart with each rotary pump mounted to one side of the gear box. An electric motor control is mounted on the wheeled cart. A first dispensing valve has a manifold having a feedback line to the first tank while the second dispensing valve has a manifold having a feedback line of the heated liquid to the second tank. An activation control allows the simultaneous activation of both first and second dispensing valves for dispensing liquids to an applicator nozzle.

### BRIEF DESCRIPTION OF THE DRAWINGS

Other objects, features, and advantages of the present invention will be apparent from the written description and the drawings in which:

FIG. 1 is a flow diagram of the plural material portion of the system;

FIG. 2 is an exploded perspective of an electric motor, gear box and rotary pumps;

FIG. 3 is a perspective view of the plural component applicator in accordance with the present invention;

FIG. 4 is a front elevation of the plural component applicator of FIG. 3;

FIG. 5 is a partially exploded perspective of the plural component applicator of FIGS. 3 and 4;

FIG. 6 is a partial perspective of a second embodiment of the plural component applicator having the motor and one pump removed; and

FIG. 7 is a partial perspective view showing the three way diverter valve of the plural component applicator.

### DESCRIPTION OF THE PREFERRED EMBODIMENT

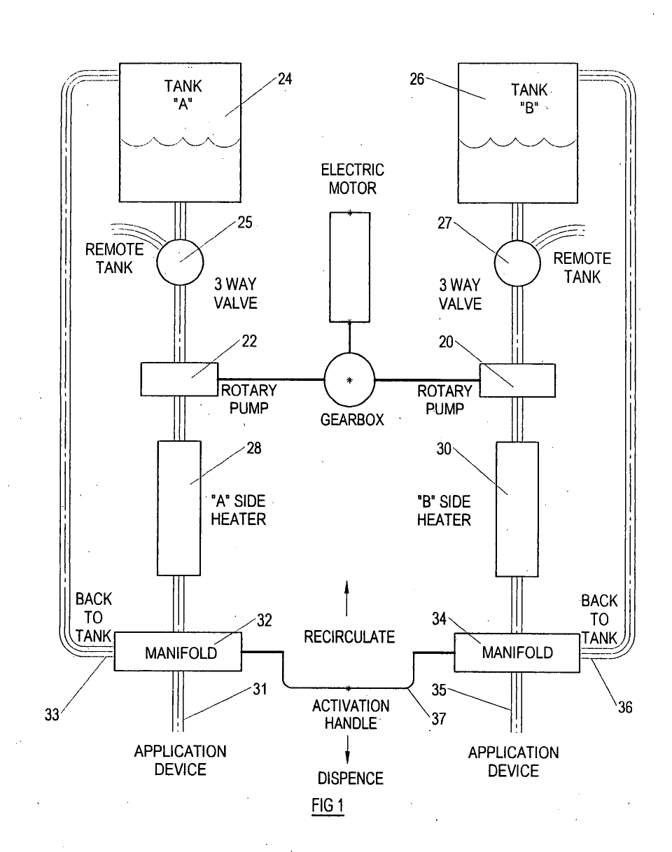

Referring to the drawings and especially to FIG. 1, a flow chart is illustrated by the operation of the pumping system in which the electric motor 12 is shown connected to gear box 14 which in turn is connected to the rotary pump 20 on one side and 22 on the other side. A tank 24 is connected through a three-way diverter valve 25 to the rotary pump 22 while a tank 26 for holding a separate liquid material to be pumped is connected through a three-way diverter valve 27 to the rotary pump 20. The rotary pump 22 is connected through a heater 28 while the rotary pump 20 is connected to a heater 30. After the liquid in the tank 24 is pumped through the heater 28, it passes through an output 31 to the spray gun passing through a valve 32, which valve controls the output 31 to the application device, such as a spray gun, injection nozzle or pouring. Simultaneously, a recirculation line 33 recirculates the heated material back to the tank 24. Similarly, the liquid being pumped from the tank 26 through the heater 30 is directed into a dispensing valve 34 and from there through the output 35,to the application device where the outputs 31 and 35 are mixed in the application device prior to dispensing. A feedback line 36 is also connected through the dispensing valve 34 to allow the recirculation of the heated liquid from the tank lead back to the tank 26. The valves 32 and 34 are controlled simultaneously by an activation handle 37 for dispensing the liquids from tank 24 and 26 simultaneously to the spray gun.

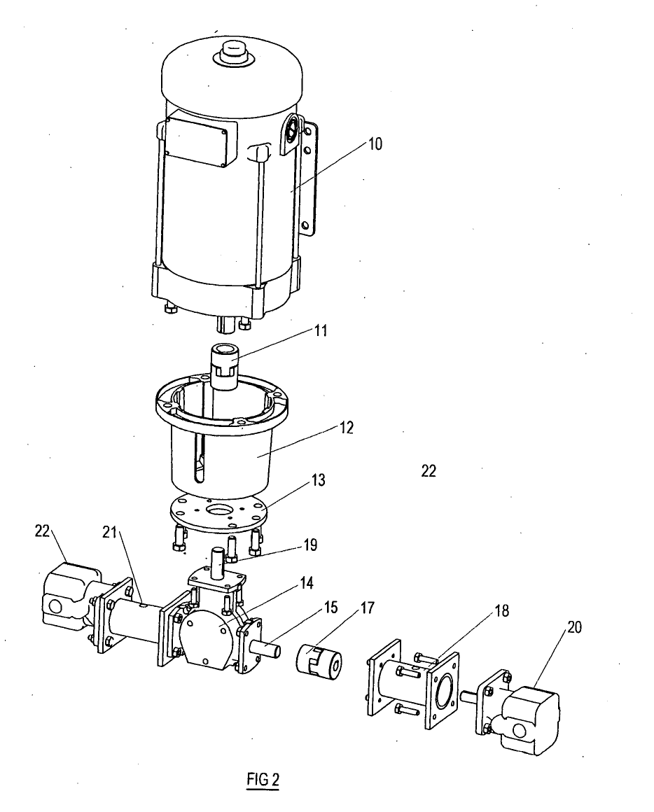

Referring to FIG. 2, an electric motor 10 is connected through couplings 11 to a motor output housing 12 which is connected by an adaptor plate 13 to a gear box 14 having an output shaft 15 and 16 from each side of the gear box 14. The output shaft 15 is connected through a coupling 17 through a lubrication housing 18 to the pump 20. Similarly, an output shaft 16 is connected through a second lubrication housing 21 to a second rotary pump 22 so that the pumps 20 and 22 are driven simultaneously by the electric motor 10 through the gear housing 14.

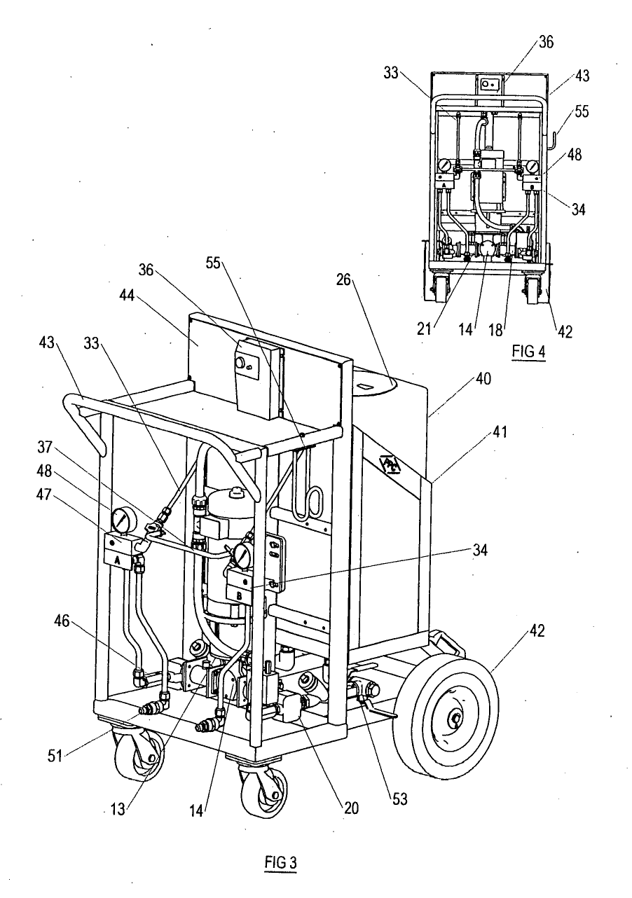

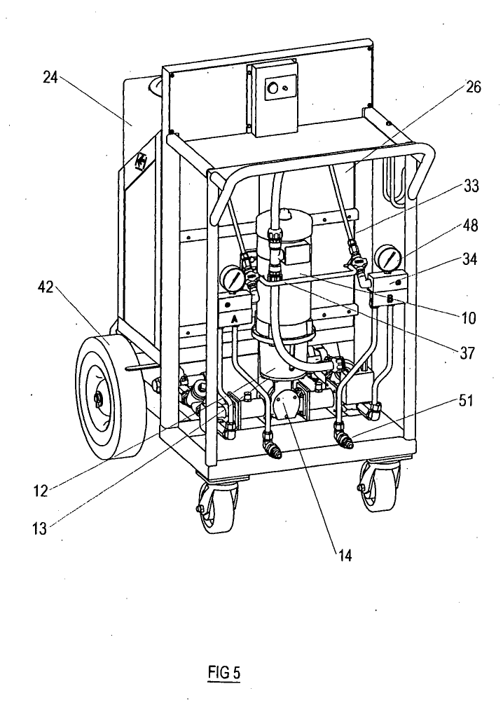

Referring to FIGS. 3, 4 and 5, a plural component applicator 40 is illustrated. The applicator 40 is mounted in a cart 41 having a plurality of wheels 42 for rolling the applicator 40 into position. Cart 40 also has a handle 43 for grasping and rolling the cart 41. The electric motor 10 is mounted in the cart and is attached to the housing 12. The electric motor output shaft is coupled to the gear box 14. Gear box 14 output shafts are coupled through the lubrication housings 18 and 21 to the rotary pumps 20 on one side 22 on the other side. A rolling cart 41 has a face plate 44 and a cord hook 45 on one side thereof. The tanks 24 and 26 are mounted to the rear of the cart 41. Adaptor plate 13 can be seen connecting the drive housing 12 to the gear box 14. Each pump 20 and 22 is connected through a check valve 45 through a tube 46 into a manifold 47 having a pressure gauge 48 mounted thereon. Manifold 47 in turn is connected through a tube 50 into an adapter 51 for connecting a hose and application device to the left side of the plural component applicator 40. The return tube 33 is also connected between the manifold 47 and the tank 24 while the manifold activation handle 37 can be connected to both manifolds 32 and 34. The rotary pump 22 and the rotary pump 20 are each connected through a line 52 to their respective tanks 24 and 26 into a three-way diverter valve and through a pressure switch used to start and stop the machine. A speed controller 56 is mounted to the backplate 44.

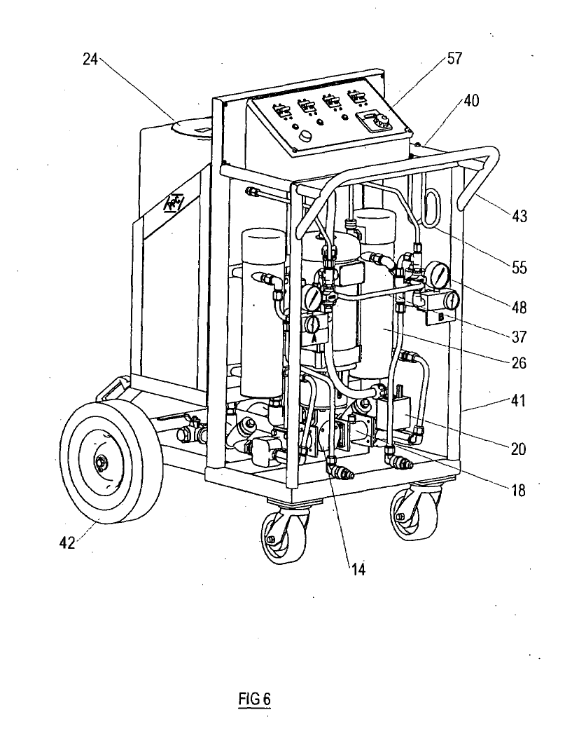

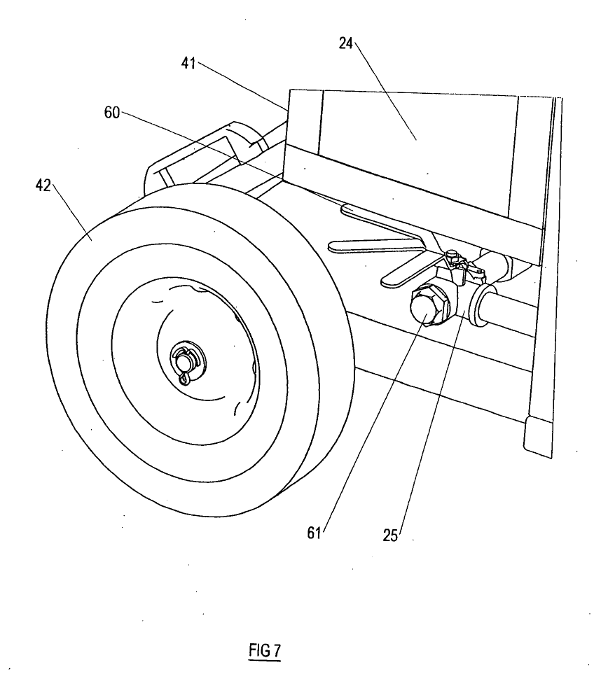

In FIG. 6, the electric motor 10 has been removed from the cart and a more detailed control box 57 has been added to provide additional controls including an electric motor speed control 58 for controlling the speed of the DC motor 10. In FIG. 6, the heater 30 is also incorporated into the housing with the heater 28 being removed.

Referring to FIG. 7, a partial perspective view of a corner of the plural component applicator is illustrated showing one corner of the rolling cart 41 having a wheel 42 and illustrating the diverter valve 25 having a handle 60 for changing the input from the tank 24 to a capped output 61. The diverter valve allows for the connection to a larger remote tank or source of one of the plural components. A matching diverter valve is, of course, located on the other side of the cart below the tank 26. Thus, a larger source of components can be connected directly to the applicator for handling larger applications of mixed liquids or for a permanent installation.

It should be clear at this time that a plural component applicator has been provided which distinguishes from prior applicators by utilizing DC electric motors for driving a performance closed loop rotary pumps which allow for the dispenser controls to be turned on or off and which has a full recirculation of each component of liquid back into the tank. The present applicator also advantageously has a three-way diverter valve allowing pumping from larger drums, pails or tanks or for permanent installation and also has various heat settings, ratios and outputs available. However, the present invention is not to be construed as limited to the forms shown which are to be considered illustrative rather than restrictive.

I claim:

1. A rotary pump plural component applicator comprising:
an electric motor having a drive shaft;
a gear box operatively connected to said electric motor drive shaft;
a first rotary pump connected to said gear box and having an input and output;
a second rotary pump connected to said gear box and having an input and an output;
a first storage tank connected to said first rotary pump input;
a second storage tank connected to said second rotary pump input;
a first heater coupled to first rotary pump output for heating liquid from said first rotary pump output;
a second heater coupled to said second rotary pump output for heating liquid from said second rotary pump output;
a first dispensing valve connected to said first heater, said first dispensing valve being coupled to an applicator nozzle; and
a second dispensing valve connected to said second heater, said second dispensing valve being coupled to an applicator nozzle;
whereby an electric motor driven rotary pump plural component applicator improves the ratio of the mixed components and of the application of the components.

2. A rotary pump plural component applicator in accordance with claim 1 in which said rotary pump plural component applicator is mounted on a wheeled cart.

3. A rotary pump plural component applicator in accordance with claim 2 in which said electric motor and gear box are mounted generally vertical to said wheeled cart.

4. A rotary pump plural component applicator in accordance with claim 3 in which said first rotary pump is mounted to one side of said gear box.

5. A rotary pump plural component applicator in accordance with claim 4 in which said second rotary pump is mounted to the other side of said gear box.

6. A rotary pump plural component applicator in accordance with claim 5 including an electric motor control mounted on said wheeled cart.

7. A rotary pump plural component applicator in accordance with claim 1 including a first three way valve connected between said first storage tank and said first rotary pump for directing a first liquid from said first storage tank or from an auxiliary storage tank to said first rotary pump input.

8. A rotary pump plural component applicator in accordance with claim 7 including a second three way valve connected between said second storage tank and said second rotary pump for directing liquid from said second storage tank or from an auxiliary storage tank to said second rotary pump input.

9. A rotary pump plural component applicator in accordance with claim 8 in which said first dispensing valve includes a manifold having a feedback line to said first tank.

10. A rotary pump plural component applicator in accordance with claim 9 in which said second dispensing valve includes a manifold having a feedback line to said second tank.

11. A rotary pump plural component applicator in accordance with claim 10 including an activation control to activate both said first and second dispensing valves for simultaneously dispensing liquids to the applicator nozzle.
